(19) United States
(12) Patent Application Publication
(10) Pub. No.: US 2020/0150859 A1
(43) Pub. Date: May 14, 2020

(54) METHOD OF OPERATING WIDGET ON AN ELECTRONIC DEVICE

(71) Applicant: Aver Information Inc., New Taipei City (TW)

(72) Inventor: Po-Hsun Wu, New Taipei City (TW)

(21) Appl. No.: 16/589,265

(22) Filed: Oct. 1, 2019

(30) Foreign Application Priority Data
Nov. 9, 2018 (TW) 107139796

(51) Int. Cl. G06F 3/0488; G06F 3/0483; G06F 3/0484

(52) U.S. Cl. CPC G06F 3/04883; G06F 3/04845; G06F 3/0483

(57) ABSTRACT

A method of operating a widget on an electronic device comprises the following steps. Step 1 is to display a widget on a display surface of the electronic device. Step 2 is to transmit the identification information corresponding to the widget to a desktop management program by the widget. Step 3 is to obtain a size information and a location information corresponding to the widget according to the identification information by the desktop management program. Step 4 is to generate an editable window based on the size information and the location information on the display surface corresponding to the widget.

### CROSS REFERENCE TO RELATED APPLICATIONS

This Non-provisional application claims priority under 35 U.S.C. § 119(a) on Patent Application No. 107139796 filed in Republic of China on Nov. 9, 2018, the entire contents of which are hereby incorporated by reference.

### BACKGROUND

### 1. Technical Field

The present invention generally relates to an operating method, and more particularly, to a method of operating widget.

### 2. Description of Related Art

Widget refers to an application extension that can be applied to many platforms or operating systems to create some desktop plug-in extensions.

Widget allows users to open or use specific applications through shortcuts, so it is also known as desktop application component. Widget technology is an application description technology that display user interfaces as scripts with extensible markup language, hypertext markup language and cascading style sheets. Generally speaking, the parsing tools of the widget can be browsers or other Apps.

At present, mainstream mobile-operating systems in the industry all provide developers with the ability to add desktop application components, such as the desktop Widget of Android system, and iOS as well. Android system provides the application program with the ability to create Widget to the desktop and user chooses to place the Widget provided by App on the desktop; iOS system also provides corresponding modules in the notification center for App to create Widget and user chooses to place the Widget provided by App in the notification center. Apps can use this feature to externalize information and operations to the desktop of the terminal for the purpose of more efficient use and more accesses to their own contents.

However, there is a rather inconvenient situation in the current use of Widget, that is, Widget cannot receive the left-right sliding input instruction on a touch screen, the reason is that this instruction will trigger the desktop management program of the system (such as Android launcher) to perform page flipping.

Referring to FIG. 1A, a conventional tablet computer 10 displays at least one first Widget 12 and one second Widget 13 on its touch screen 11, for example, the former is a search engine and the latter is a calendar.

Taking the first Widget 12 as an example, when user clicks on the icon of the first Widget 12, the application linked will be triggered. As shown in FIG. 1B, it will open the application (or mobile application, App) of the search engine, and users can enter text or symbols at the position cursor 122 of the input column 121.

Refer to FIG. 1A again, the example of the second Widget 13, when user clicks on the “add” symbol 131 of the second Widget 13, it will open the application of the calendar and enter into the interface of the new event so that users can input the calendar event.

As mentioned above, the current widget is mainly used for information updating, it is impossible to execute left-right sliding input instruction due to the limitation of desktop management program and cannot be used as canvas, whiteboard or input directly on it, which narrow the range of its application. Therefore, how to improve these disadvantages and provide an input instruction that can perform left-right sliding on the widget so as to expand its application is one of the current important subject matters.

### SUMMARY OF THE INVENTION

In view of the above, one of the purposes of this invention is to provide a method of operating a widget on an electronic device so that the widget can expand its functions in addition to just displaying information.

To achieve this purpose, the invention provides a method of operating a widget on an electronic device with the following steps: step 1 is to display a widget on the display surface of an electronic device; step 2 is to transmit an identification information corresponding to the widget to a desktop management program by the widget; step 3 is to obtain a size information and a location information corresponding to the widget according to the identification information by the desktop management program; step 4 is to generate an editable window based on the size information and the location information on the display surface corresponding to the widget.

In one embodiment of the present invention, the method of operating the widget on the electronic device further includes generating an editable content through editing on the editable window with a sliding touch input instruction, a click touch input instruction, a mouse input instruction or a keyboard input instruction.

In one embodiment of the present invention, wherein the sliding touch input instruction includes a left-right sliding command.

In one embodiment of the present invention, wherein after editing on the editable window, the following steps are required: storing the editable content of the editable window as an image file, closing the editable window, and displaying the image file at the position corresponding to the widget.

In one embodiment of the present invention, wherein after editing on the editable window, the following steps are required: launching a browser and displaying the search result according to the editable content.

In one embodiment of the present invention, wherein when the editable window is generated, an image information shall be displayed on the editable window correspondingly.

In one embodiment of the present invention, wherein the editable window is a floating window or a window of a terminal application.

In one embodiment of the present invention, wherein the size information and location information are a coordinate information of the widget displayed on the display surface.

In addition, in order to achieve the above purpose, this invention provides a method of operating a widget on an electronic device, which includes the following steps: step 1 is to display a widget on a display surface; step 2 is to trigger an auxiliary window and display it on the display surface corresponding to the location of the widget; step 3 is to execute an instruction on the auxiliary window.

In one embodiment of the present invention, wherein the step of executing instructions on the auxiliary window includes sliding touch and displaying the touch trajectory.

In one embodiment of the present invention, wherein the step of executing instructions on the auxiliary window includes typing on the auxiliary window and starting the search function of the browser.

In one embodiment of the present invention, wherein the step of executing instructions on the auxiliary window includes displaying an image information on the auxiliary window.

In one embodiment of the present invention, wherein when touching the area outside the auxiliary window on the display surface, the auxiliary window will be closed.

From above, the method of operating a widget in this invention is to trigger the editable window (or the auxiliary window) that will be superimposed on the display surface of the electronic device corresponding to the location of the widget. Because the size and location of editable windows (or auxiliary windows) are the same as those of the widget, users will have the same feeling as operating on the widget when edit on it, and the edited results can also be displayed on the widget, thus solving the problem of unavailable editing on the widget and extending the application of it.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

The parts in the drawings are not necessarily drawn to scale, the emphasis instead being placed upon clearly illustrating the principles of at least one embodiment. In the drawings, like reference numerals designate corresponding parts throughout the various diagrams, and all the diagrams are schematic.

FIGS. 1A and 1B are schematic diagrams showing the conventional method of operating the widget.

FIG. 2 is a flow chart showing a method of operating widget on an electronic device according to a first embodiment of the invention.

FIGS. 3A to 3C are schematic diagrams showing a display of the electronic device cooperated with the flow chart of FIG. 2.

FIG. 4 is a flow chart showing a method of operating widget on an electronic device according to a second embodiment of the invention.

FIG. 5 is a schematic diagram showing a display of the electronic device cooperated with the flow chart of FIG. 4.

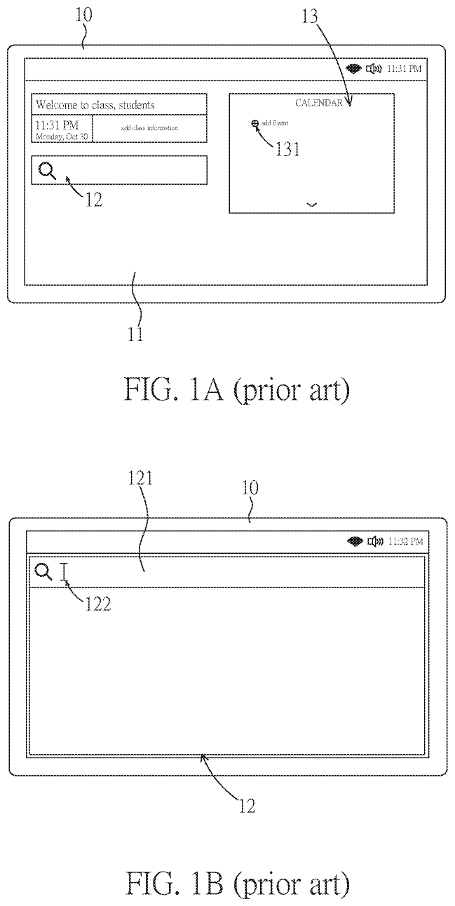

### DETAILED DESCRIPTION

Reference will now be made to the drawings to describe various inventive embodiments of the present disclosure in detail, wherein like numerals refer to like elements throughout.

In this invention, the Widget, which can add dynamic content to a Web page based on HTML, such as browsing counter, real-time meteorological information or flight information. Desktop Management Program is an application that manages functions related to the desktop of an electronic device, such as the Launcher of Android.

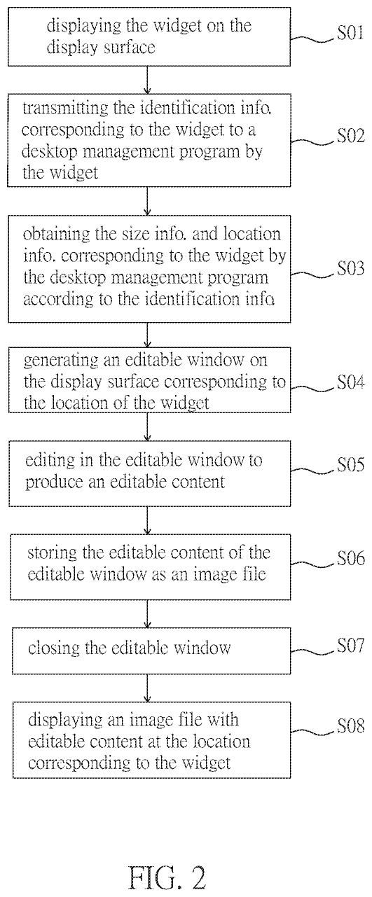

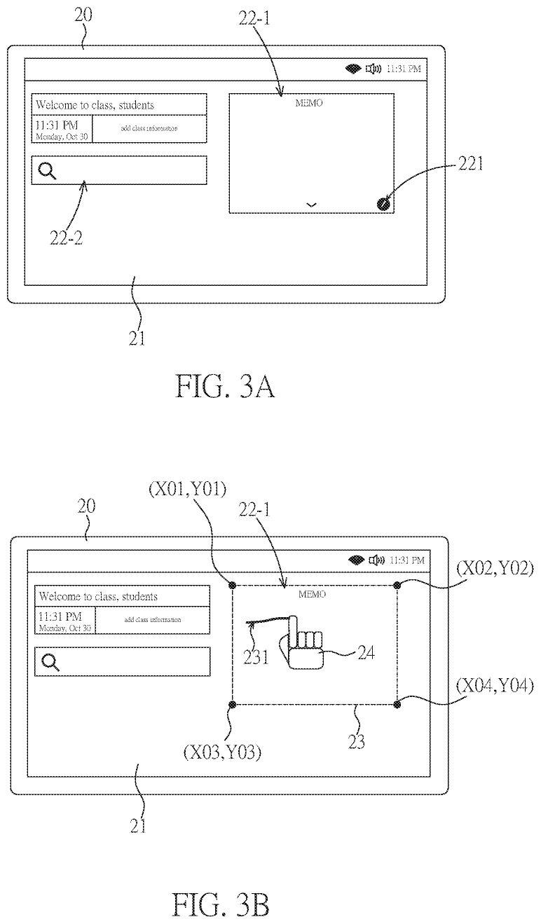

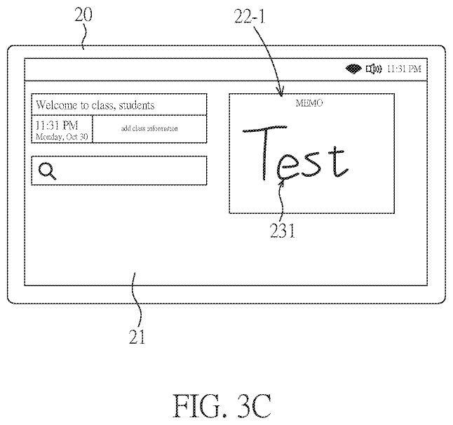

FIG. 2 is a flow chart showing the method to operate a widget on an electronic device according to the first embodiment of this invention. The method includes step S01 to S08. FIGS. 3A to 3C are schematic diagrams showing the display screen of an electronic device applied with the flow chart of FIG. 2. As shown in FIG. 3A, an electronic device 20 has a display surface 21, and a plurality of widget 22-1 and 22-2 can be displayed on the display surface 21. Among them, the electronic device 20 can be a mobile communication device likes a mobile phone, tablet computer, laptop, touch panel and whiteboard but not limited to this. For easy understanding, the following embodiments are illustrated by widgets with different functions. For example, widget 22-1 may be a “memo” and widget 22-2 may be a “search engine”, but this case is not limited to that. In the first embodiment, the operation of widget 22-1 is illustrated as an example.

Please refer to FIGS. 2 to 3C for the following description, step S01 is to display the widget 22-1 and 22-2 on the display surface 21 of the electronic device 20, in which widget 22-1 and 22-2 can be the default of electronic device 20, or can be added by users themselves. In some embodiments, the widget 22-1 contains at least one graphical button that user can enter corresponding instructions by touching on it.

Step S02 is to transmit the identification information corresponding to the widget 22-1 to a desktop management program by the widget 22-1 (not shown in the figure). In this embodiment, when user clicks the graphical button (e.g. edit icon 221), the widget 22-1 will output the identification information (e.g. name, identifier, etc.) representing itself to the desktop management program, which is an application that manages all information on the desktop of the electronic device 20, at least storing the information related to each widget.

Step S03 is to obtain the size information and location information corresponding to the widget 22-1 by the desktop management program according to the identification information. In this embodiment, the size information and location information of the widget 22-1 can be shown as coordinates, so when the widget 22-1 is placed on the display surface 21, its coordinate information will then be transmitted to the desktop management program. Here, the graph presented by the widget 22-1 is a rectangular, so the desktop management program will store the coordinates of four endpoints (X01, Y01), (X02, Y02), (X03, Y03) and (X04, Y04) that represent the size and location information of the widget 22-1.

Step S04 is to generate an editable window 23 on the display surface 21 corresponding to the location of the widget 22-1 based on the size and location information. The editable window 23 is a floating window, which is superimposed on the coordinates (X01, Y01), (X02, Y02), (X03, Y03) and (X04, Y04), user can only observe the original widget 22-1 on the display surface 21 but cannot perceive the existence of the floating window.

In addition, the editable window can also be a window of a terminal application program in other embodiments, which is displayed on the display surface corresponding to the location of the widget after opening the terminal application program and setting the size and location of its window according to the coordinate information. Accordingly, user can edit at the location corresponding to the widget without noticing the existence of this window.

Step S05 is to edit in the editable window 23 to produce an editable content 231. In this embodiment, user gives a sliding touch input instruction (as shown in FIG. 3B) in the editable window 23 by touching the display surface 21 with finger 24 so as to draw or write, and display the touch trajectory in the editable window 23, in which the sliding touch input instruction means sliding in any direction, including a left-right one. In this way, the problem that the existing technology cannot execute left-right sliding instruction on the widget can be solved. Furthermore, the editable content can be generated by a touch input instruction, a mouse input instruction and a keyboard input instruction, etc.

In this embodiment, when user clicks on an area outside the editable window 23 on the display surface 21, it will be regarded as an instruction to close the editable window 23. At the same time, the editable content 231 in the editable window 23 will be stored as an image file by executing step S06. The image file can be in any commonly used format like bitmap, JPEG TIFF or others, and it can be stored in the storage unit of the electronic device 20, such as a buffer (not shown in the figure). In other embodiments, a button can also be set in the editable window for the user to close the window by clicking on it.

Next, please refer to FIG. 3C, Step S07 is to close the editable window, and Step S08 is to display an image file with editable content 231 at the location corresponding to the widget 22-1. In this embodiment, the image file is loaded by the widget 22-1 in the storage unit of the electronic device 20 and displayed on the display surface 21.

From above, the editable window can be triggered by the cooperation of widget and desktop management program to execute the left-right sliding touch instruction that is not available in the existing technology, so as to extend the application of the widget.

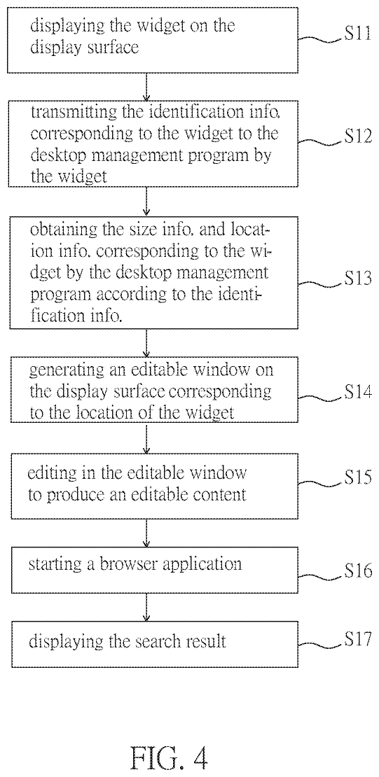

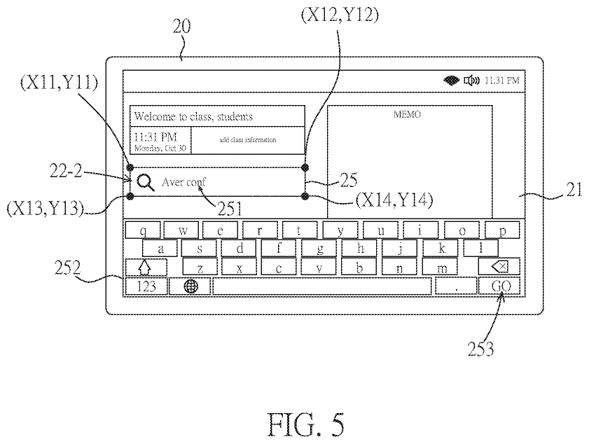

Please refer to FIGS. 4 and 5 below to illustrate the method of operating interface macros on an electronic device according to a second embodiment of the invention, and the operation of the widget 22-2 is illustrated as an example in the second embodiment.

The method of operating a widget includes Step S11 to S17, in which S11 is the same as S01 of the first embodiment, so it will not be repeated here.

Step S12 is to transmit the identification information corresponding to the widget 22-2 to the desktop management program by the widget 22-2.

Step S13 is to obtain the size information and location information corresponding to the widget 22-2 by the desktop management program according to the identification information. Similar as the first embodiment, the size and location information can be shown as coordinates. Here, the graph presented by the widget 22-2 is a rectangular, so the desktop management program will store the coordinates of four endpoints (X11, Y11), (X12, Y12), (X13, Y13) and (X14, Y14) that representing the size and location information of the widget 22-2.

Step S14 is to generate an editable window 25 on the display surface 21 corresponding to the location of the widget 22-2 based on the size and location information. The editable window 25 is a floating window same as the editable window 23 in the first embodiment, which is superimposed on the coordinates (X11, Y11), (X12, Y12), (X13, Y13) and (X14, Y14), user can only observe the original Widget 22-2 on the display surface 21 but cannot perceive the existence of the floating window.

Step S15 is to edit in the editable window 25 to produce an editable content 251. In this embodiment, the keyboard 252 can be started when user executes a touch input instruction in the editable window 25 by touching the display surface 21. After that, the user can generate the editable content 251 in the editable window 25 through the keyboard; and after complete the input, the user can click on the button 253 to send out the instruction of search.

In this embodiment, when user clicks on an area outside the editable window 25 on the display surface 21, it will be regarded as an instruction to close the editable window 25.

Then, step S16 is to start a browser application (not shown), and step S17 is to start the search engine according to the editable content 251 and display the search result.

It should be noted that the editable window above can also be called an auxiliary window, which can display image information in addition to executing the instruction of editing in this window as mentioned in the above embodiments. For example, live videos or real-time images of video calls are displayed in the auxiliary window.

In summary, the method of operating a widget on an electronic device in this invention is to trigger an editable window (or auxiliary window) so as to superimpose the editable window on the display surface of the electronic device corresponding to the location of the widget. Because the size and location of the editable window are the same as that of the widget, the existence of the editable window will not be noticed when editing on it, so that user will have the same feeling as editing on the widget and the edited results can also be loaded and then displayed on the widget, which will solve the problem that edit is unavailable on the widget and thereby extend the application of the widget.

Even though numerous characteristics and advantages of certain inventive embodiments have been set out in the foregoing description, together with details of the structures and functions of the embodiments, the disclosure is illustrative only. Changes may be made in detail, especially in matters of arrangement of parts, within the principles of the present disclosure to the full extent indicated by the broad general meaning of the terms in which the appended claims are expressed.

What is claimed is:

1. A method of operating a widget on an electronic device, comprising:
displaying a widget on a display surface of an electronic device;
transmitting an identification information corresponding to the widget to a desktop management program by the widget;
obtaining a size information and a location information corresponding to the widget according to the identification information by the desktop management program; and
generating an editable window according to the size information and the location information on the display surface corresponding to the widget.

2. The method of operating the widget of claim 1, further comprising:
generating an editable content through editing on the editable window with a sliding touch input instruction, a click touch input instruction, a mouse input instruction or a keyboard input instruction.

3. The method of operating the widget of claim 2, wherein after editing on the editable window, further comprising:
storing the editable content of the editable window as an image file;
closing the editable window; and
displaying the image file at the position corresponding to the widget.

4. The method of operating the widget of claim 2, wherein the sliding touch input instruction includes a left-right sliding command.

5. The method of operating the widget of claim 2, wherein after editing on the editable window, further comprising:
launching a browser; and
displaying a search result according to the editable content.

6. The method of operating the widget of claim 1, wherein the editable window is a floating window or a window of a terminal application.

7. The method of operating the widget of claim 1, wherein the size information and the location information are a coordinate information of the widget displayed on the display surface.

8. The method of operating the widget of claim 1, wherein after generating the editable window, further comprising:
displaying an image information on the editable window correspondingly.

9. A method of operating a widget on an electronic device, comprising:
displaying a widget on a display surface;
triggering an auxiliary window and displaying the auxiliary window on the display surface corresponding to a location of the widget; and
executing an instruction on the auxiliary window.

10. The method of operating the widget of claim 9, wherein the step of executing the instruction on the auxiliary window, comprising:
sliding touch and displaying the touch trajectory on the auxiliary window.

11. The method of operating the widget of claim 9, wherein the step of executing the instruction on the auxiliary window, comprising:
typing on the auxiliary window; and
starting a search function of the browser.

12. The method of operating the widget of claim 9, wherein the step of executing the instruction on the auxiliary window, comprising:
displaying an image information on the auxiliary window.

13. The method of operating the widget of claim 9, further comprising:
closing the auxiliary window when an area outside the auxiliary window shown on the display surface is touched.
